(19) United States
(12) Patent Application Publication
(10) Pub. No.: US 2003/0046502 A1
(43) Pub. Date: Mar. 6, 2003

(54) Computer data backup system and restore system therefor

(76) Inventor: Masanori Okazaki, Tokyo (JP)

Correspondence Address: DICKSTEIN SHAPIRO MORIN & OSHINSKY LLP, 1177 Avenue of the Americas, New York, NY, 10036-2714, US

(21) Appl. No.: 10/226,269

(22) Filed: Aug. 23, 2002

(30) Foreign Application Priority Data
Aug. 28, 2001 (JP) 2001-258022

(51) Int. Cl. G06F 12/16

(52) U.S. Cl. 711/162

(57) ABSTRACT

This invention is intended to make it unnecessary to introduce a backup-dedicated unit by utilizing a storage area provided in an existing computer (a POS unit, in particular), to compact, distribute and store backup data by introducing an encoder and a decoder to compact and expand data, and to also introduce a restore mechanism. After a content of a memory M1 of a POS unit (POS1) is compacted by an encoder C1, the content is split, distributed to and backed up in memories M2 to M5 of POS units (POS2 to POS5). If a fault occurs to the memory M1 of the POS unit (POS1), the respective pieces of data backed up in the POS units (POS2 to POS5) are combined, decoded by the decoder D1 and restored in the memory M1.

### BACKGROUND OF THE INVENTION

1. Field of the Invention

The present invention relates to a backup system for backing up data stored in a computer and a restore system therefor. More specifically, the present invention relates to a system for backing up the content of a memory in a POS (Point of Sales) unit, in another POS unit which is connected thereto through a network and a restore system corresponding to this backup system.

2. Description of the Related Art

As a conventional POS data backup system, there is known storage medium duplexing. In the duplexing, the same data is stored in two different locations to thereby decentralize fault risk.

However, the conventional storage medium duplexing system for POS data has the following disadvantages.

According to the storage medium duplexing, a hardware is added to a system to provide redundancy and thereby enhance the reliability of the system. If so, however, cost is doubled. In addition, if the number of POS terminals increases, cost is disadvantageously pushed up accordingly. Besides, if a hardware which has high reliability is employed and duplexing is performed to prevent a fault which rarely occurs, then cost, labor and the like are sometimes, disadvantageously wasted.

### SUMMARY OF THE INVENTION

It is an object of the present invention to make it unnecessary to introduce a backup-dedicated unit by utilizing the storage area of an existing computer (a POS unit, in particular) and to provide a computer data backup system and a restore system therefor which enable compacting, distributing and storing backup data by introducing an encoder and a decoder to compact and expand data and which also introduce a restore mechanism.

The present invention can improve the fault tolerance of data held by a POS unit in a POS system.

In FIG. 1, POS units POS2 to POS5, which are connected to each other on a network, store and hold the content of the memory Ml of a POS unit POS1 which is also connected to the POS2 to POS5 on the network, as M1-2 to M1-5 through the network, respectively. Controllers 1 to 5 prepared in the respective units POS2 to POS5 control the storage and holding of the content of the memory M1.

Likewise, the content of the memory of the unit POS2 is distributed to and backed up in the POS1 and POS3 to POS5. Namely, the content of the memory of one POS is backed up in the memories of the other POS units.

In this case, if the memory content M1 is stored as it is in the other memories, efficient storage capacity cannot be ensured. To prevent this, the content M1 is compacted by an encoder C1 which operates in the controller 1 and then distributed to the memories of the other POS units as M1-2 to M1-5, respectively. At this moment, the content M1 is encoded to satisfy the following expression:

Capacity of M1>(capacity of M1-2)+(capacity of M1-3)+(capacity of M1-4)+(capacity of M1-5).

By doing so, even if a significant fault occurs to the memory M1 in the unit POS1 and the data of the memory M1 is lost, the distributed data backed up in the other POS2 to POS5 can be restored by decoders D2 to D5. Likewise, it is expected to ensure that the reliabilities of the POS2 to POS5 enhance.

As stated above, according to the present invention, the data held in each POS unit is encoded, distributed to a plurality of other POS units and stored and backed up in the plurality of other POS units. Therefore, even if a fault occurs to one POS unit and the data in this POS unit is lost, it is possible to completely restore the data as long as the remaining POS units operate normally. Besides, by encoding the data of the POS unit using the encoder, it is possible to decrease data capacity.

According to the first aspect of the present invention, there is provided a backup system for backing up data of computers connected to one another, comprising: split means for splitting source data stored in a first computer to a plurality of pieces of split data; and means for storing the respective pieces of split data in a plurality of second computers connected to the first computer.

The backup system may further comprise means for compacting the source data stored in the first computer, and the split means may split the source data stored in the first computer after being compacted.

The backup system may further comprise means for compacting the respective pieces of split data, and the respective pieces of split data may be stored in the plurality of second computers, after being compacted.

In the backup system, each of the first and second computers may be a Point-of-Sales or POS unit.

According to the second aspect of the present invention, there is provided a restore system for restoring data of a computer, comprising: means for reading a plurality of pieces of split data stored in a plurality of second computers; combining means for combining the plurality of pieces of read split data, and for restoring source data; and means for restoring the source data in a first computer connected to the plurality of second computers.

In case of the restore system, the plurality of pieces of split data may be obtained by compacting and then splitting the source data, the restore system may further comprise means for expanding the compacted source data, and the compacted source data may be expanded and then restored in the first computer.

In case of the restore system, the plurality of pieces of split data may be obtained by splitting and then compacting the source data, the restore system may further comprises means for expanding the plurality of pieces of compacted split data, and the plurality of pieces of compacted split data may be individually expanded and then combined.

In the restore system, each of the first and the second computers may be a Point-Of-Sales or POS unit.

### BRIEF DESCRIPTION OF THE DRAWINGS

FIG. 1 is a block diagram showing the configuration of a backup method and a restore method according to the first embodiment of the present invention;

FIG. 2 is the first conceptual view showing an operation for the backup method in the first embodiment of the present invention;

FIG. 3 is the second conceptual view showing an operation for the backup method in the first embodiment of the present invention;

FIG. 4 is a conceptual view showing an operation for the restore method in the first embodiment of the present invention;

FIG. 5 is a flow chart showing the operation for the backup method in the first embodiment of the present invention;

FIG. 6 is a flow chart showing the operation for the restore method in the first embodiment of the present invention; and

FIG. 7 is a block diagram showing the configuration of a backup method and a restore method according to the second embodiment of the present invention.

### DESCRIPTION OF THE PREFERRED EMBODIMENTS

The embodiments of the present invention will be described hereinafter in detail with reference to the drawings.

[First Embodiment]

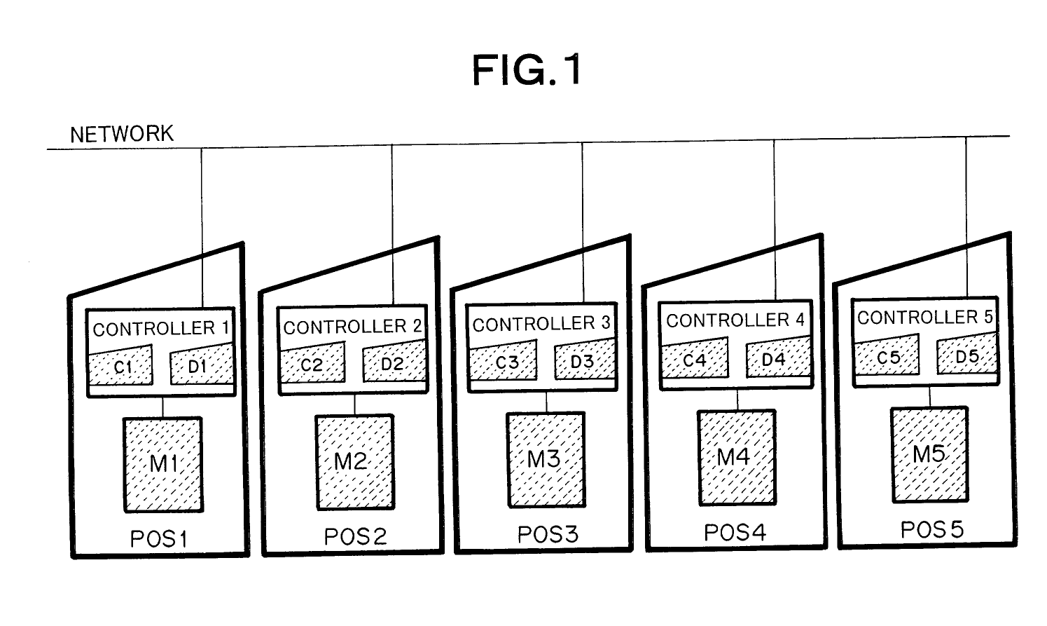

Referring to FIG. 1, five POS units POS1 to POS5 connected to one another on a network are shown as the first embodiment of the present invention. Respective POS units include a controller which manages and controls POS data.

The respective POS units include data storage areas (M1 to M5) and distributed storage control portions (controllers 1 to 5). Each controller n (where n=1, 2, . . . , 5) includes an encoder Cn which compacts data and a decoder Dn which expands the compacted data. Further, each controller n controls data to be distributed to and stored in the other POS units on the network.

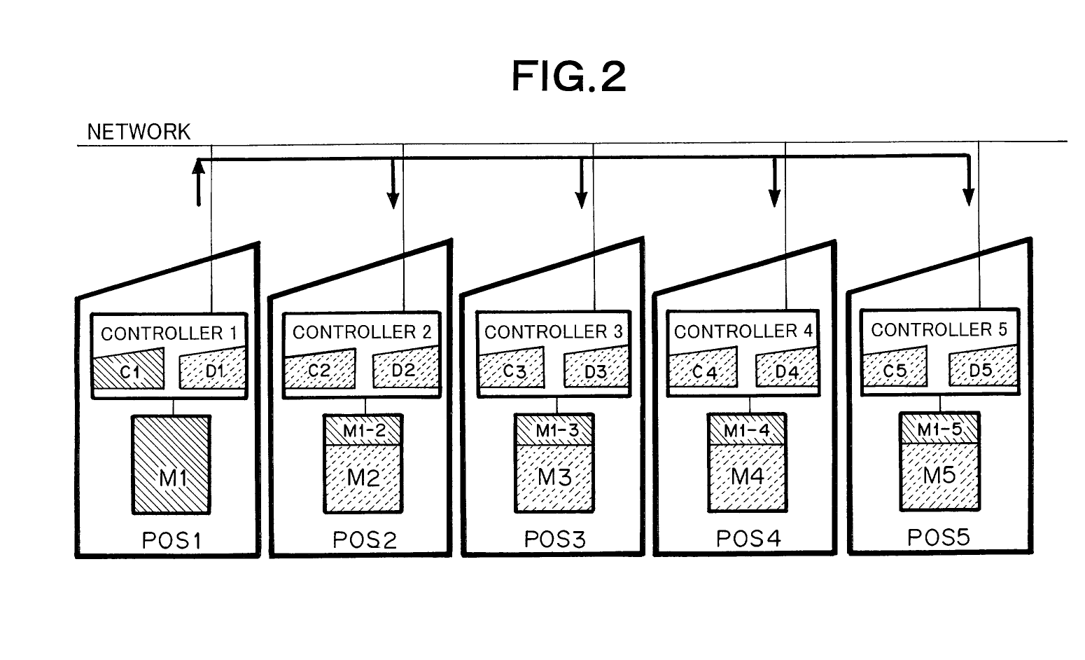

Referring to FIG. 2, a detailed configuration in which the data of the POS unit POS shown in FIG. 1 is distributed to and stored in the POS2 to POS5 is shown.

In FIG. 2, the controller 1 compacts data M1 held in the POS1 using the encoder C1, and splits the compacted data to data M1-2 to M1-5. The controller 1 transmits the data M1-2 to M1-5 thus compacted and split to the POS2 to POS5 through the network, respectively.

If the POS unit POS2 receives the data M1-2, the controller 2 of the POS2 stores the data M1-2 in the storage area M2 of the POS2. Likewise, if the POS unit POSn receives the data M1-n, the controller n of the POSn stores the data M1-n in the storage area Mn of the POSn.

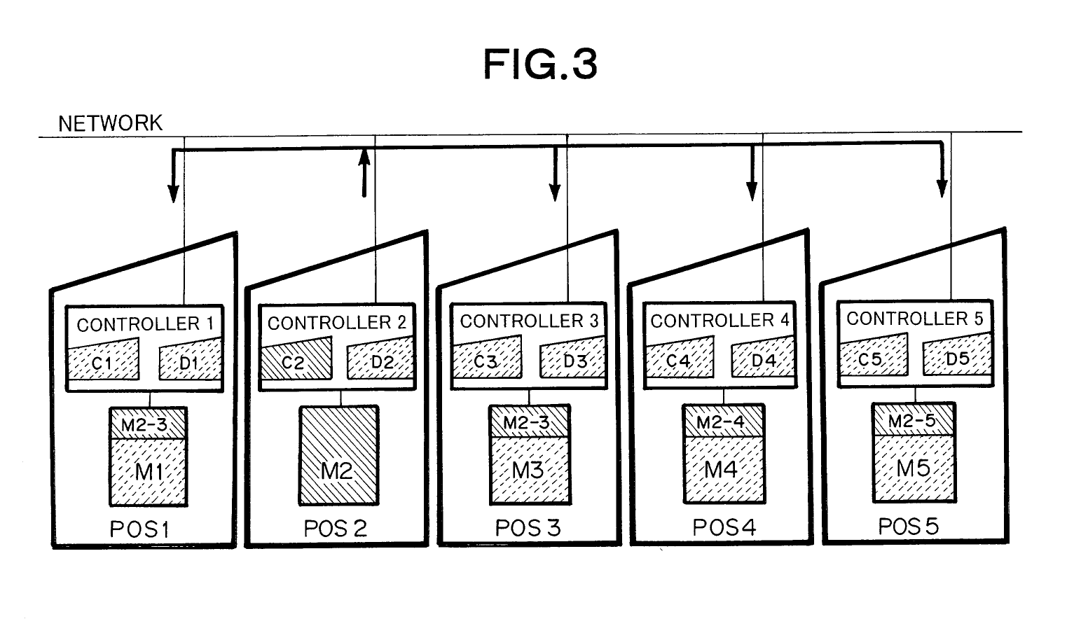

FIG. 3 shows a state in which after the data of the POS2 is reduced in size by an encoder C2, the data is split and the split data is stored in the POS1 and POS3 to POS5.

Likewise, after the data of the POS3 is reduced in size by an encoder C3, the data is split and the split data is stored in the POS1, POS2, POS4 and POS5. After the data of the POS4 is reduced in size by an encoder C4, the data is split and the split data is stored in the POS to POS3 and POS5. After the data of the POS5 is reduced in size by an encoder C5, the data is split and the split data is stored in the POS to POS4.

That is, the data of one POS is backed up in the other POSs' on the network. The encoders and decoders are constituted by hardware, software or a combination thereof.

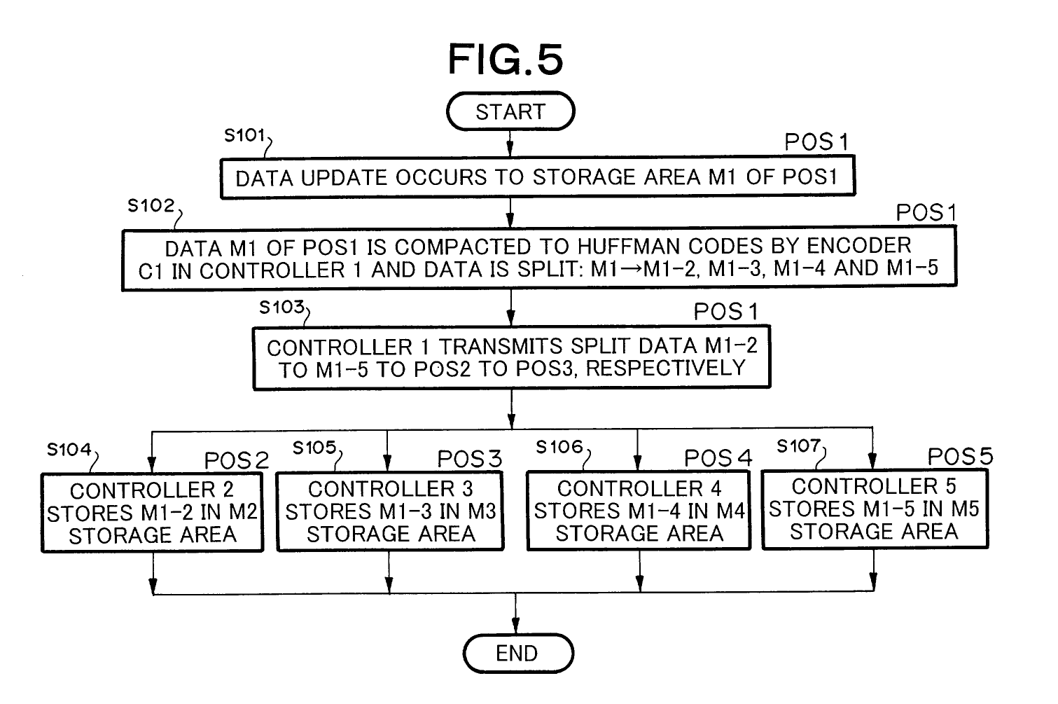

The distributed storage operation shown in FIG. 1 will next be described with reference to the flow chart shown in FIG. 5.

Referring to FIG. 5, if data update occurs to the storage area Ml of the POS1 (in step S101), the controller 1 in the POS1 detects the update and reduces and splits the data M1 of the POS1 to M1-2, M1-3, M1-4 and M1-5 using the encoder C1 in the controller 1 (M1→M1-2, M1-3, M1-4 and M1-5).

The encoders C1 to C5 are designed to satisfy the following expression:

Capacity of M1>(capacity of M1-2)+(capacity of M1-3)+(capacity of M1-4)+(capacity of M1-5).

In this embodiment, the entire content of the storage area M1 is compacted to Huffman codes to thereby create data M1′. The data M1′ is then split to M1-2 to M1-5 so that the respective pieces of split data are equal in size (in step S102).

The controller 1 transmits the split data M1-2, M1-3, M1-4 and M1-5 to the POS units POS2, POS3, POS4 and POS5 through the network, respectively (in step S103).

In the POS unit POS2 which receives the split data M1-2, the controller 2 stores the split data M1-2 in the storage area M2 (in step S104). Likewise, in the POS unit POSn which receives split data M1-n, the controller n stores the split data M1-n in the storage area Mn (in steps S105 to S107).

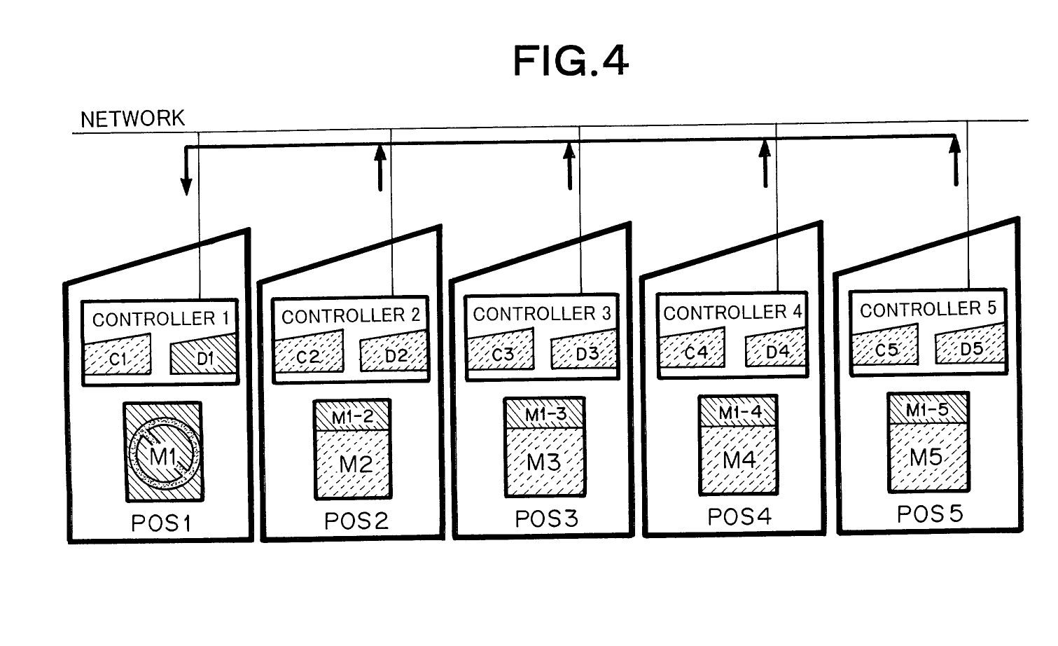

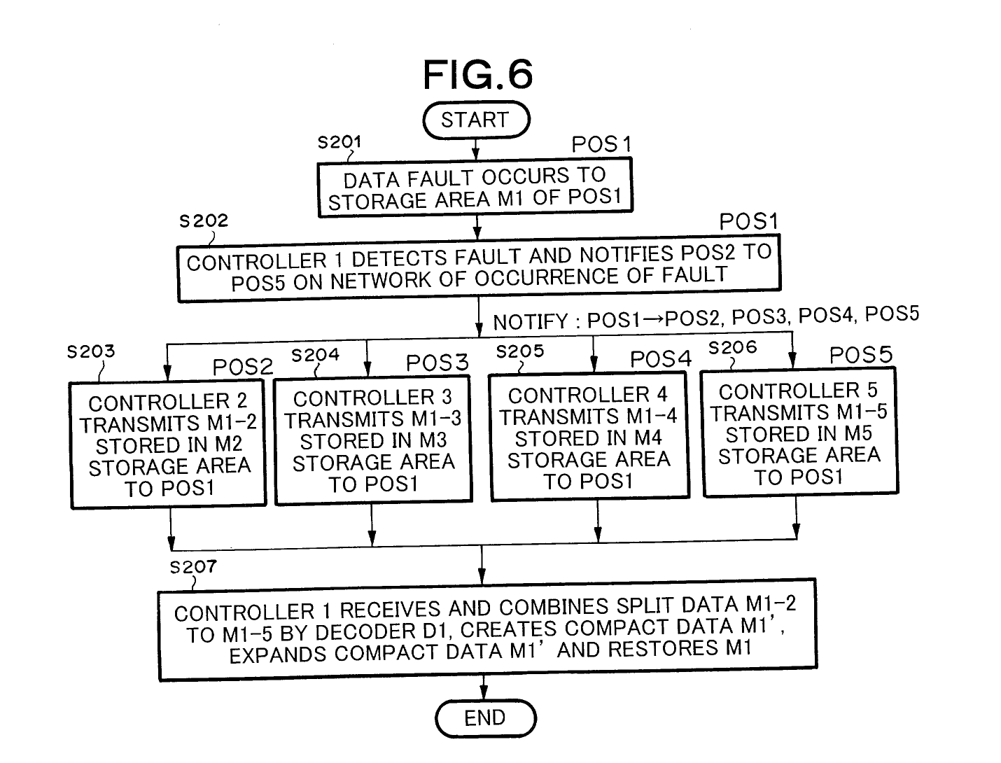

A data restore processing if a data storage fault occurs to the POS unit POS1 as shown in FIG. 4 will next be described with reference to the flow chart of FIG. 6.

If a data fault occurs to the storage area M1 of the POS1 (in step S201), the controller 1 detects the fault and notifies the POS2, POS3, POS4 and POS5 other than the POS1 of the occurrence of the fault (in step S202). Alternatively, the POS1 to POS5 may regularly perform polling with respect to one another and thereby check whether the other POS units are normal. If it is impossible to check that the POSn unit is normal and the other POS units cannot receive normal signals, i.e., receive time-out, then the other POS units may determine that a fault occurs to the POSn. The controller 2 of the POS2 unit, which is notified of the occurrence of a fault to the POS1 unit, transmits the data M1-2 held in the storage area M2 of the POS2 to the controller 1 of the POS1 (in step S203). Likewise, the controller n of the POSn, which is notified of the occurrence of a fault to the POS1, transmits the data M1-n in the storage area Mn of the POSn to the controller 1 of the POS1 (in steps S204 to S206).

If receiving the data M1-2 to M1-5, the controller 1 of the POS1 combines the data M1-1 to M1-5 to create compact data M1′, expands the compact data M1′ using a decoder D1 provided in the controller 1, and thereby restores the data M1 (in step S207).

[Second Embodiment]

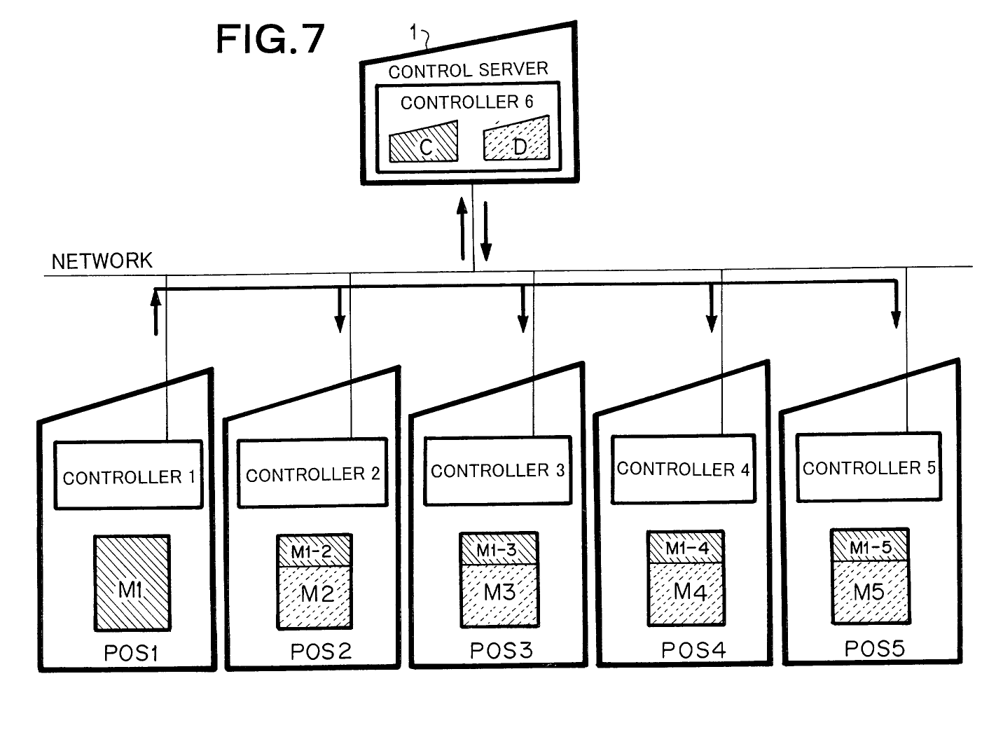

The second embodiment of the present invention is equal in basic configuration to the first embodiment. However, the second embodiment is characterized by the location of an encoder and a decoder. FIG. 7 shows the configuration of the second embodiment. In FIG. 7, the encoder and the decoder are integrally provided in a control server 1 on the network. If a distributed storage processing is performed as shown in FIG. 2, the encoder provided in the control server 1 is employed. If a restore processing is performed as shown in FIG. 4, the decoder provided in the control server 1 is employed. In addition, a controller 6 provided in the control server 1 detects a fault which occurs to each POS unit. In this embodiment, it is unnecessary to package an encoder and a decoder in each POS unit. Therefore, if there are many POS units, it is possible to advantageously reduce cost.

As can be understood, in the second embodiment, the encoder and the decoder are centralized in one location of the control server. Therefore, the second embodiment has an advantage in that it is unnecessary to package a plurality of encoders and decoders in the respective POS units.

While the backup system for backing up data of each POS unit has been described in the above embodiments, the present invention is not limited thereto but is also applicable to a system in which ordinary computers instead of POS units are connected to one another on the network.

Moreover, while the data of each POS unit is split after being compacted in the above-stated embodiments, the present invention is not limited thereto. The data of each POS unit may be compacted after being split.

As stated so far, the present invention exhibits the following advantages.

The first advantage is as follows. The data stored in each POS unit is distributed to and stored in other POS units on the network. Due to this, even if a storage fault occurs to one POS unit, the data of the POS unit to which the fault occurs can be restored as long as the other POS units operate normally. In addition, since the POS data is distributed to and stored in a plurality of POS units, fault risk can be distributed, as well.

The second advantage is as follows. The encoder and the decoder based on the principle of Huffman coding are employed to compact data which is to be distributed and stored. Due to this, it is unnecessary to provide so large storage areas necessary for backup. In addition, if the Huffman coding principle is not utilized but a stronger compact algorithm, e.g., a high-rate algorithm is employed, then it is possible to freely change the size of backup data (e.g., M1-2 and M1-3) to be held in other POS units. As a result, it is possible to ensure flexibility suited to the design policy of a system which pays attention to the reduction of backup capacity, a system which is required to perform a backup processing at high rate or the like.

The third advantage is as follows. A memory capacity required for each POS unit to back up the data of the other POS units remains unchanged, irrespective of the number of the POS units. The reason is as follows. If it is assumed that the number of POS units connected to one another on the network is N, it suffices to back up data reduced to 1/(N−1) of the original data for each of (N−1) POS units.

What is claimed is:

1. A backup system for backing up data of computers connected to one another, comprising:
split means for splitting source data stored in a first computer to a plurality of pieces of split data; and
means for storing the respective pieces of split data in a plurality of second computers connected to the first computer.

2. The backup system according to claim 1, further comprising:
means for compacting the source data stored in the first computer, and wherein
the split means splits the source data stored in the first computer after being compacted.

3. The backup system according to claim 1, further comprising:
means for compacting the respective pieces of split data, and wherein
the respective pieces of split data are stored in the plurality of second computers after being compacted.

4. The backup system according to claim 1, wherein
each of the first and second computers is a Point-of-Sales or POS unit.

5. A restore system for restoring data of a computer, comprising:
means for reading a plurality of pieces of split data stored in a plurality of second computers;
combining means for combining the plurality of pieces of read split data, and for restoring source data; and
means for restoring the source data in a first computer connected to the plurality of second computers.

6. The restore system according to claim 5, wherein
the plurality of pieces of split data are obtained by compacting and then splitting the source data,
the restore system further comprises means for expanding the compacted source data, and
the compacted source data is expanded and then restored in the first computer.

7. The restore system according to claim 5, wherein
the plurality of pieces of split data are obtained by splitting and then compacting the source data,
the restore system further comprises means for expanding the plurality of pieces of compacted split data, and
the plurality of pieces of compacted split data are individually expanded and then combined.

8. The restore system according to claim 5, wherein each of the first and said second computers is a Point-Of-Sales or POS unit.
